(19) United States
(12) Patent Application Publication
(10) Pub. No.: US 2025/0231392 A1
(43) Pub. Date: Jul. 17, 2025

(54) IMAGING SYSTEM

(71) Applicant: National University of Singapore, Singapore (SG)

(72) Inventors: Pakorn KANCHANAWONG, Singapore (SG); Wei WANG, Singapore (SG); Zengxin HUANG, Singapore (SG)

(73) Assignee: National University of Singapore, Singapore (SG)

(21) Appl. No.: 18/853,557

(22) PCT Filed: Apr. 24, 2023
(86) PCT No.: PCT/SG2023/050278

§ 371 Date: Oct. 2, 2024

(30) Foreign Application Priority Data
Apr. 26, 2022 (SG) 10202204424S

(51) Int. Cl. G02B 21/36; G02B 21/16

(52) U.S. Cl. CPC G02B 21/361; G02B 21/16

(57) ABSTRACT

An imaging system is provided. The imaging system includes a beamsplitter, a first optical arm, a second optical arm and or more detectors arranged to receive an image from the beamsplitter. The first optical arm includes a first objective lens, a first phase plate and a first mirror. The first mirror is arranged to direct emission from the first objective lens through the first phase plate towards the beamsplitter. The second optical arm includes a second objective lens, a second phase plate and a second mirror. The second mirror is arranged to direct emission from the second objective lens through the second phase plate towards the beamsplitter. The first and second objective lenses and are in an opposing relationship.

### CROSS-REFERENCE TO RELATED APPLICATIONS

The present application is a national phase entry under 35 U.S.C. § 371 of International Application No. PCT/SG2023/050278, filed Apr. 24, 2023, published in English, which claims the benefit of Singapore Patent Application No. 10202204424S, filed Apr. 26, 2022, the disclosures of which are hereby incorporated by reference.

### FIELD OF THE INVENTION

The present invention relates in general to single-molecule localization microscopy and more particularly to an imaging system for the same.

### BACKGROUND OF THE INVENTION

In recent years, super-resolution fluorescence microscopy has been intensively developed and applied to a wide range of biological applications, unveiling key insights hitherto inaccessible to light-based imaging.

Amongst super-resolution microscopy techniques, single-molecule localization microscopy (SMLM), which depends on stochastic spatiotemporal control of the density of emitting fluorophores and their subsequent localization, are capable of achieving lateral resolution in the order of several to tens of nanometers. SMLM has been extended to realize three-dimensional (3D) super-resolution by several strategies. However, for many of the 3D SMLM approaches, the axial (z) resolution is typically at least 2 to 3 times poorer than the lateral (xy) resolution. This poses limits on the application of SMLM for a number of quantitative applications in the inherently 3D context of cells and tissues such as mapping nanoscale architecture of protein complexes or nanocluster analysis of biological molecules.

Ultra-high resolution 3D SMLM has been demonstrated using an interferometric configuration, typically based on dual opposed objective lens in the 4Pi geometry coupled with multi-phase detection. Interferometric SMLM (iSMLM) techniques such as interferometric photo-activated localization microscopy (iPALM) provide a major gain in axial resolution, up to 3 to 4 times better than the lateral resolution. 3D iSMLM imaging is based on multi-phase interferometry for high-precision z-localization and conventional localization analysis for xy-localization. The optical design of iSMLM encodes high-precision z-position information via self-interference of fluorescence emission, which can be retrieved by multi-phase detection. Ultra-high resolution 3D imaging using the iSMLM interferometric configuration provides superior resolution in the nanoscale range compared to standard super-resolution microscopy. Interferometric photo-activated localization microscopy (iPALM) and related interference-based single molecule localization microscopy (iSMLM) techniques have been demonstrated to achieve ultra-high 3D spatial resolution, especially in the axial (z)-dimension, approaching Quantum limits. Consequently, ultra-high resolution of iSMLM methods have been instrumental in imaging ultrastructural-level organization in animal cells and virus particles as well as providing molecular specificity in correlative super-resolution and electron microscopy.

However, in comparison to conventional SMLM techniques which have seen widespread adoption, iSMLM techniques have thus far remained highly specialized due to highly complex optical instrumentation, calibration, and operation requirements. Current implementations of iPALM/iSMLM typically require multiple interference channels that necessitate complex optical instrumentation and use of custom-engineered optical components. Conventionally, at least three detection channels are needed to maximize full imaging depth allowed by interferometry, which in turn requires complex optical configuration of multiple precisely-aligned beamsplitters or custom-engineered optical components to realize three or four detection channels. This has limited experimental throughput and represents a major barrier for wider adoption by the biological research community. Thus, the application and accessibility of this powerful imaging modality, particularly in biological research, have remained highly specialized. To date, no commercialized ISMLM have been available, despite its demonstrated superior performance.

### SUMMARY OF THE INVENTION

Accordingly, in a first aspect, the present invention provides an imaging system. The imaging system includes a beamsplitter, a first optical arm, a second optical arm and one or more detectors arranged to receive an image from the beamsplitter. The first optical arm includes a first objective lens, a first phase plate and a first mirror. The first mirror is arranged to direct emission from the first objective lens through the first phase plate towards the beamsplitter. The second optical arm includes a second objective lens, a second phase plate and a second mirror. The second mirror is arranged to direct emission from the second objective lens through the second phase plate towards the beamsplitter. The first and second objective lenses are in an opposing relationship.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is a schematic diagram illustrating an imaging system in accordance with an embodiment of the present invention;

FIG. 2A illustrates amplitude and phase of coherent point-spread functions (PSFs) for two detectors of the imaging system of FIG. 1 before interference;

FIG. 2B illustrates PSFs for two detectors of the imaging system of FIG. 1 between −200 nm and 200 nm;

FIGS. 2C and 2D illustrate theoretical 3D precisions between 4Pi PSF, 2Pi PSF, astigmatic PSF, and viSMLM PSF;

FIG. 3A is a schematic diagram illustrating an optical setup for testing the PSFs patterns of the imaging system 10 of FIG. 1;

FIG. 3B illustrates simulated PSFs in several positions at z=0 nm, 60 nm, 120 nm and 240 nm with rotating angles of the vortex being respectively Δθ=0°, 45°, 90° and 180°;

FIG. 3C illustrates corresponding measured PSFs by moving BS2 along the azimuthal direction;

FIG. 4A illustrates amplitude and phase of coherent PSFs for two cameras before interference;

FIG. 4B illustrates PSFs for two detectors of the imaging system of FIG. 1 under the influence of spherical aberration;

FIGS. 4C and 4D illustrate theoretical 3D precisions between 4Pi PSF and viSMLM PSF with and without the spherical aberration;

FIG. 5A is a graph of coefficients for an optimized Zernike PSF;

FIG. 5B illustrates optimised Zernike PSFs for each detector; and

FIGS. 5C and 5D illustrate theoretical 3D precisions between 4Pi PSF, optimized Zernike PSF, and viSMLM PSF.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

The term “optical arm” as used herein refers to all optical components between a specimen and a beamsplitter including, for example, one or more of an objective lens, one or more mirrors and one or more phase plates.

The term “phase plate” as used herein refers to an optical device that modifies the phase of light passing through. Accordingly, the term “vortex phase plates” as used herein refers to an optical device that creates a phase singularity in a centre of a field of view.

The term “objective lens” as used herein refers to an optical component closest to a specimen that gathers and focusses light from the specimen.

The term “4Pi geometry” as used herein refers to an optical arrangement in which emission from a specimen is collected from both sides using a pair of concentric dual opposed objective lenses.

The term “piezoelectric mirror mount” as used herein refers to a type of mirror mount that uses piezoelectric actuators to adjust a position of a mirror with high precision and stability.

The term “tube lens” as used herein refers to an optical component that focusses an image produced by an objective lens onto an imaging sensor or eyepiece.

The term “about” as used herein refers to both numbers in a range of numerals and is also used to indicate that a value includes the standard deviation of error for the device or method being employed to determine the value. The term “about” as used herein can allow for a degree of variability in a value or range, for example, within 10%, within 5%, or within 1% of a stated value or of a stated limit of a range.

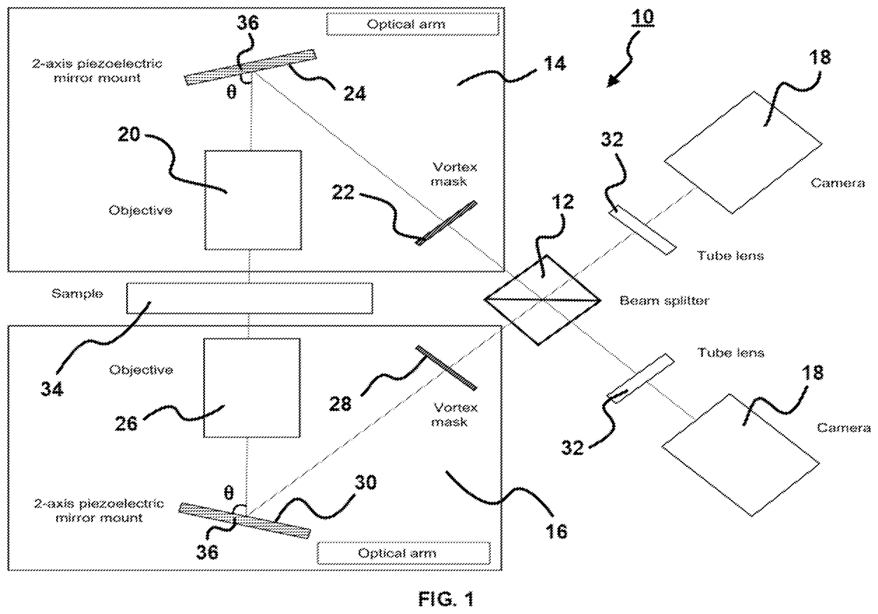

Referring now to FIG. 1, an imaging system 10 is shown. The imaging system 10 includes a beamsplitter 12, a first optical arm 14, a second optical arm 16 and one or more detectors 18 arranged to receive an image from the beamsplitter 12. The first optical arm 14 includes a first objective lens 20, a first phase plate 22 and a first mirror 24; the second optical arm 16 includes a second objective lens 26, a second phase plate 28 and a second mirror 30. The first and second objective lenses 20 and 26 are in an opposing relationship. The first mirror 24 is arranged to direct emission from the first objective lens 20 through the first phase plate 22 towards the beamsplitter 12; a second mirror 30 is arranged to direct emission from the second objective lens 26 through second phase plate 28 towards the beamsplitter 12.

In the embodiment shown, the imaging system 10 includes one or more tube lenses 32, each of the one or more tube lenses 32 being positioned between the beamsplitter 12 and a corresponding one of the one or more detectors 18.

A sample 34 may be received between the first and second optical arms 14 and 16. The first and second optical arms 14 and 16 may be in an upper and lower configuration as shown in FIG. 1.

The imaging system 10 is a type of super-resolution fluorescence microscopy which is a category of imaging techniques that has been applied to a wide range of biological applications over the past decades. Its principle of operation is based on single-molecule localization microscopy (SMLM) that depends on stochastic spatiotemporal control of the density of emitting fluorophores and their subsequent localization in combination with interferometry. Thus, it may be classified as an Interferometric SMLM (ISMLM) imaging technique.

The beamsplitter 12 may be a non-polarizing beamsplitter and may be configured to split unpolarized light at a specific reflection/transmission (R/T) ratio of 50/50. In the present embodiment, each emitted photon propagates through both the first (upper) and second (lower) optical arms 14 and 16 and self-interferes at the 50/50 non-polarizing beamsplitter 12, which is positioned equidistant between the first and second optical arms 14 and 16. The beamsplitter 12 effectively performs multiphase projection onto two optical output paths, where emission and/or notch filters (not shown) may be positioned as necessary.

The dual opposed first and second objective lenses 20 and 26 may be co-axially aligned in a 4Pi geometry to collect emitted fluorescence through the first (upper) and second (lower) optical arms 14 and 16. Emission gathered by each of the first and second objective lenses 20 and 26 is directed toward the beamsplitter 12 via the first and second turning mirrors 24 and 30.

Each of the first and second mirrors 24 and 30 may be oriented at an angle θ of about 67.5 degrees (°) relative to a central axis of the corresponding first or second objective lens 20 or 26 to direct the emission gathered by each of the first and second objective lenses 20 and 26 towards the beamsplitter 12. Each of the first and second mirrors 24 and 30 may be mounted on a two-axis piezoelectric mirror mount 36 for precise alignment.

Each of the first and second phase plates 22 and 28 may be a vortex phase plate. Each of the first and second phase plates 22 and 28 may be positioned between a corresponding one of the first and second objective lenses 20 and 26 and the beamsplitter 12. Advantageously, placement of a vortex phase plate 22 and 28 in each of the 4pi detection arms 14 and 16 results in self-interfered point-spread functions (PSFs) that counter-rotate, turning z-axis interference to an azimuthal direction, and hence encode z-position information. The placement of the vortex phase plate 22 and 28 in the Fourier plane generates annular or doughnut-shaped PSF. In the imaging system 10, two (2) doughnut-shaped PSFs from the first (upper) and second (lower) objective lenses 20 and 26 interfere in the azimuthal direction to form bi-lobe PSFs that rotate in the azimuthal direction as a function of an axial position of an emitter (not shown). Compared to unmodified PSF, the doughnut-shaped PSF has a similar z-depth range and thus does not belong in the category of axial extension PSF. Instead, the axial position is encoded in the azimuthal phases.

The image may be formed by the tube lens 32 and detected the one or more detectors 18. This may, for example, be by two (2) cameras or projected onto different areas of the same camera.

A single beamsplitter design for three-dimensional (3-D) interferometric single-molecule localization microscopy has thus been described. Advantageously, by using a pair of vortex phase plates 22 and 28 in conjunction with a 4Pi detection configuration and a single 50/50 beamsplitter 12, the imaging system 10 modifies the PSF by Fourier-plane phase modulation to achieve extended axial range super-resolution fluorescence microscopy. Further advantageously, use of a single beamsplitter 12 and 2-channel detection simplifies and economizes system construction, calibration and operation. To simplify the imaging system 10, it is desirable to use only two phase shifts, that is, only one (1) beamsplitter. Accordingly, with the imaging system 10, the z-position may be retrieved using only two detection channels, thereby greatly simplifying the optical layout.

### Examples

To evaluate the resolution performance of the imaging system 10 in comparison to earlier iSMLM methods, an analysis of the relevant PSFs was performed.

For a high-NA fluorescence microscopy, coherent PSFs E; for each objective lens (j=1, 2 for lower and upper, respectively) with a maximum light collection angle θ, may be expressed by Equation (1) below:

$${E}_{j} ( {ρ}_{p} , z , {φ}_{p} ) = - \frac{i k}{2 π} {\int }_{0}^{2 π} d φ {\int }_{0}^{Θ} d θ {T}_{j} ( θ , φ ) sin θ \sqrt{cos θ} * exp [ {( - 1 )}^{j} ikz cos θ ] exp ( ik {ρ}_{p} sin θcos ( {φ}_{p} - φ ) ) \qquad ( 1 )$$

where Tⱼ(j=1, 2) represents pupil functions for each arm, respectively, k represents wavenumber, (θ, φ) represents coordinates in an object plane, and (ρₚ, φₚ) represents polar coordinates in an image plane.

In iSMLM, detection signals on cameras Iₘ are the interference between two coherent PSFs with different phase shifts ϕₘ as represented by Equation (2) below:

$${I}_{m} = {\vert {E}_{1} + {E}_{2} exp ( i {ϕ}_{m} ) \vert}^{2} \qquad ( 2 )$$

For iSMLM with unmodified PSF, the coherent PSF may be simplified as represented by Equation (3) below:

$${E}_{j} ( {ρ}_{p} , z , {φ}_{p} ) = - ik {\int }_{0}^{Θ} d θsinθ \sqrt{cos θ} * exp [ {( - 1 )}^{j} ikz cos θ ] {J}_{0} ( k {ρ}_{p} sin θ ) \qquad ( 3 )$$

The term exp [−ikz cos θ] in the PSF for the lower objective (E₁) and the term exp [ikz cos θ] in the PSF for the upper objective (E₂) interfere to generate intensity oscillation in the axial direction. This axial intensity oscillation forms the basis for axial super-resolution in iSMLM. Axial position can be calculated by solving the phase retrieval problem with Equation (2), where at least three phase shifts are needed. If only one beamsplitter is used, there would be only two (2) phase shifts, −π/2 and π/2. The axial position cannot be retrieved throughout the full 2Pi period.

To realize iSMLM with a single beamsplitter 12, commercially available vortex phase plates 22 and 28 are used in the imaging system 10. The phase term for the vortex phase plate 22 and 28 for each optical arm 14 and 16 may be expressed by Equation (4) below:

$$T = exp ( \pm i ϕ ) \qquad ( 4 )$$

whereby the complex conjugate (i.e. by flipping the phase mask) ensures that the PSFs overlap. With the placement of these phase plates as shown in FIG. 1, the resulting PSF may be expressed by Equation (5) below:

$${E}_{j} ( {ρ}_{p} , z , {φ}_{p} ) = - i k {\int }_{0}^{Θ} d θ {T}_{j} ( θ , φ ) sin θ \sqrt{cos θ} * exp [ {( - 1 )}^{j} i ( kz cos θ - {φ}_{p} ) ] {J}_{1} ( k {ρ}_{p} sin θ ) \qquad ( 5 )$$

An imaging configuration was simulated using a pair of Nikon 60× NA 1.49 TIRF objective lenses with emission wavelength set to 670 nm typical for organic SMLM fluorophore such as AlexaFluor 647.

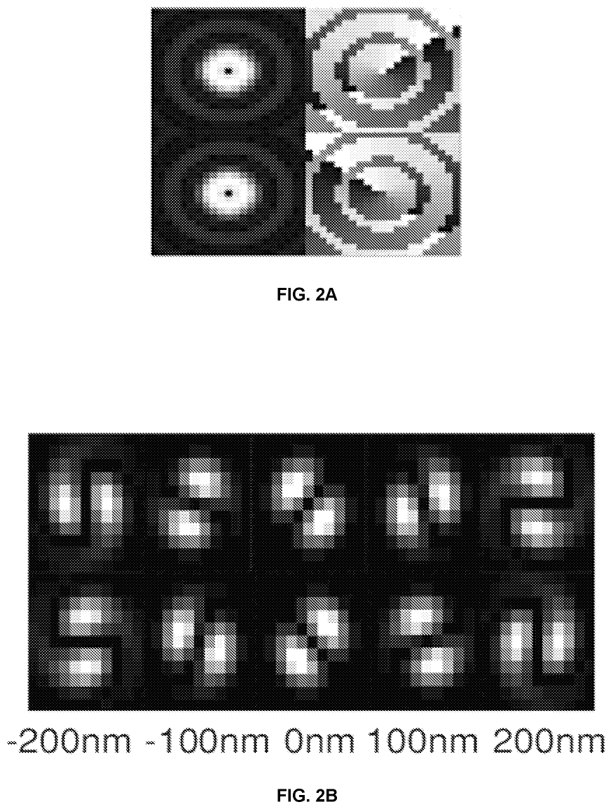

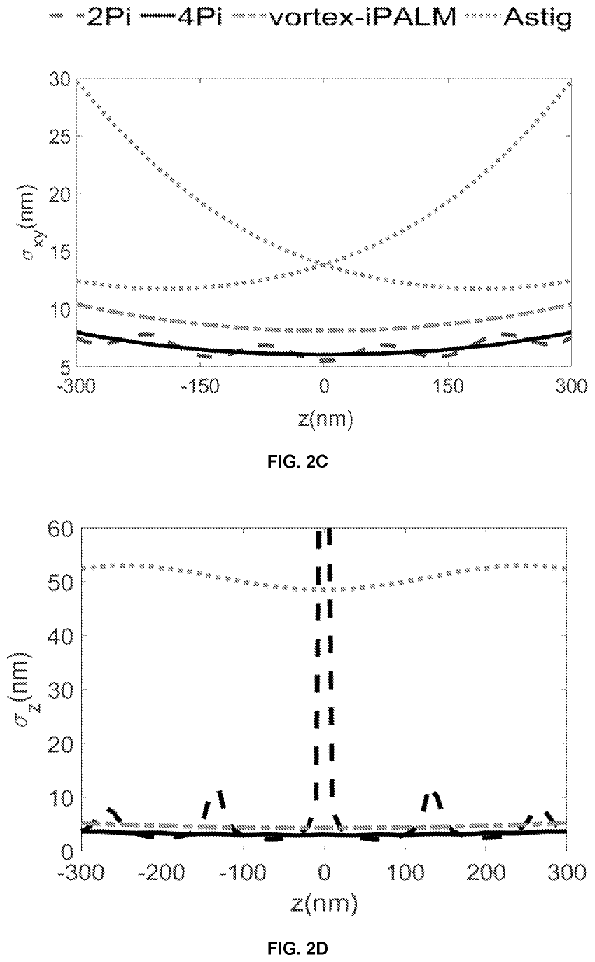

Referring now to FIG. 2A, amplitude and phase images of coherent point-spread functions (PSFs) for both optical arms 14 and 16 of the imaging system 10 are shown. As can be seen from FIG. 2A, the amplitudes show an identical doughnut shape as expected. In comparison, the phases of the two PSFs are rotating in the azimuthal direction. Importantly, the rotation directions of the first (upper) and second (lower) arms 14 and 16 are opposite, thus indicating that the axial information is encoded in the azimuthal direction. The relationship between the z-position and the angle is defined by the term exp [(−1)^{j}i(kz cos θ−φₚ)] in Equation (5). Amplitude and phase of the coherent PSFs before interference for the two cameras where the opposed orientations in the azimuthal direction are clearly visible in the phase images.

Referring now to FIG. 2B, PSFs for the first and second cameras 30 of the imaging system 10 between-200 nm and 200 nm are shown. Following interference at the beamsplitter 12, the two doughnut-shaped PSFs overlap and interfere with two phase shifts (−π/2, π/2). The constructive and destructive interference forms peaks and valleys in the azimuthal direction, resulting in two (2) lobes in the detection PSFs as shown in FIG. 2B. As the axial position of the fluorescence molecules changes from −200 nm to 200 nm, the detection PSF effectively forms a double helix that rotates in the azimuthal direction. As can be seen from FIG. 2B, the two lobes are orientating in the azimuthal direction after the interference. Subsequently, the axial position can be directly determined from the rotation angle. In the imaging system 10, the PSF encodes the axial information in the azimuthally rotating phases, and thus the constructive and nonconstructive interference are shifted from the axial direction in the conventional 4Pi PSFs to the azimuthal direction in the PSFs of the imaging system 10. This makes iSMLM with one beamsplitter 12 possible.

Referring now to FIGS. 2C and 2D, theoretical 3D precisions between 4Pi PSF, 2Pi PSF, astigmatic PSF, and viSMLM PSF when 1000 signal and 20 background photons were considered are shown. In FIGS. 2C and 2D, Cramer-Rao Lower Bound (CRLB) localization precisions for various 3D SMLM methods (ISMLM as well as astigmatism-based 3D SMLM) were calculated using signal photon number Nₚₕ and background N_{bg} at 1000 and 20, respectively. For astigmatism-SMLM, the lateral (x, y) and axial (z) resolution are ˜20 and ˜50 nm, respectively. In contrast, iSMLM using unmodified 4Pi PSFs exhibits a small precision increase in the lateral dimension and ultra-high axial resolution of 3 nm. For astigmatism-SMLM, the axial resolution is 2 to 3 times poorer than the lateral, while for iSMLM the axial resolution is 3 to 4 times better than the lateral resolution.

To further evaluate the performance of the imaging system 10, a single beamsplitter performance of conventional iSMLM is next calculated. Here, with only two phase shifts from one beamsplitter, the axial position cannot be calculated for the entire detection range, as reflected in the singularity and side peaks in the theoretical resolution as shown in FIGS. 2C and 2D. Therefore, this confirms that current iSMLM methods cannot be used with one beamsplitter to realize full 3D super-resolution.

As can be seen from FIGS. 2C and 2D, the PSF of the imaging system 10 (viSMLM PSF) has a similar performance with the 4Pi PSF. In the imaging system 10, the resulting double helix PSF is generated from the interference between two doughnut-shaped PSFs in contrast to conventional axial extension double-helix PSFs in which the PSF is modified in the Fourier plane of individual objective lenses. Additionally, the vortex phase plate 22 and 28 does not lead to extended z-depth range. Therefore, the PSFs of the imaging system 10 have a similar depth of focus as the unmodified 4Pi PSFs. Theoretically, the imaging system 10 is not expected to sacrifice lateral resolution and axial resolution relative to current iSMLM, while having a simpler construction and operation.

For the imaging system 10, the lateral and axial resolution is shown in FIGS. 2C and 2D. The axial precision is approximately 4-5 nm over a depth range of 600 nm, slightly larger than for conventional iSMLM. Similarly, the lateral precision of the imaging system 10 is close to, but slightly worse than conventional iSMLM. In calculations performed, background photons are considered to be from the specimen only, and background noise from the camera is neglected. If these factors are considered, the performance of PSFs of the imaging system 10 are expected to be approximately similar to conventional 4Pi PSFs. These results indicate a similar degree of 3D resolution, with minor differences in performance that are likely to be negligible in actual experiments.

Although the theoretical z-depth ranges for both conventional iSMLM and the imaging system 10 may be multiple wavelengths according to CRLB analysis. In practice, most iSMLM methods is applied within a depth range of λ/(2nₛ), where nₛ is the refractive index of the cell sample. This is due to the fact that the calculated phase is proportional to 2kz cos θ and the maximum value of the phase is only 2π. This limitation in working z-depth range is also faced by the imaging system 10 as the maximum rotation angle is finite. Moreover, the maximum rotation angle of PSFs of the imaging system 10 is only IT due to the symmetry of the rotating lobes. Here it is demonstrated that the depth of range is ˜λ/(2nₛ) for PSFs of the imaging system 10. This is due to the fact that in the PSF of the imaging system 10, the maximum contribution comes from the peaks J₁ (kρₚ sin θ), the value of cos θ in the term 2kz cos θ is around half of the one in 4Pi PSFs. This decreases the speed of rotation in PSFs of the imaging system 10, making the working depth range to be around λ/(2nₛ) if rotation angle is used to fit the axial position. In other words, the PSFs of the imaging system 10 for two (2) fluorophores separated by an axial distance of 250 nm are expected to have the same orientation, i.e. phase-wrapping. Fitting methods using experimental PSFs may also be used to extend the working depth range.

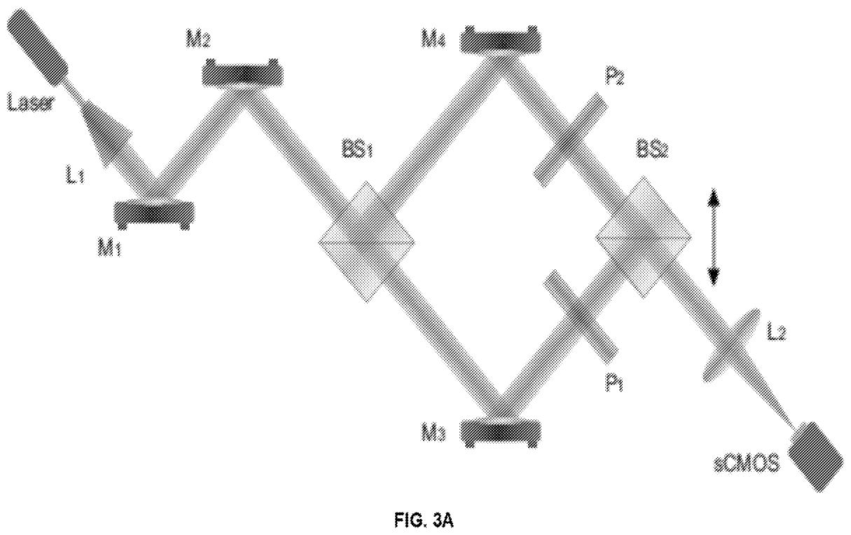

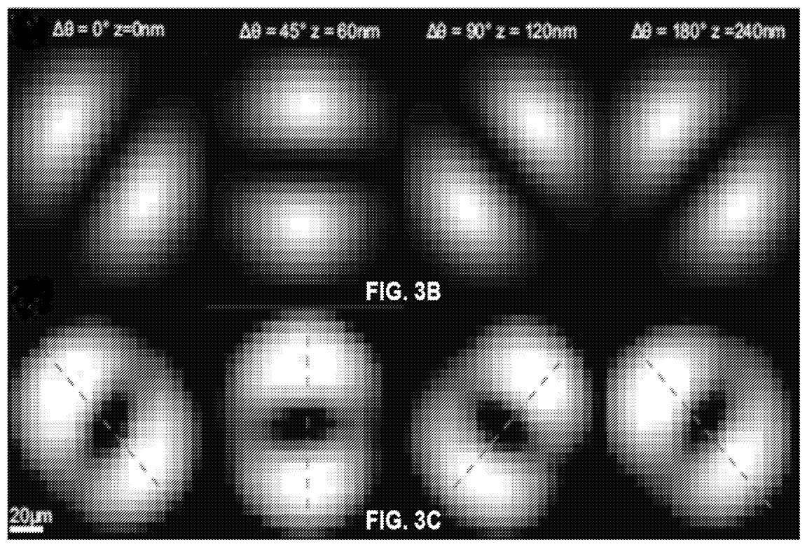

Referring now to FIG. 3A, an optical setup for testing the PSFs patterns of the imaging system 10 is shown. The primary test optical setup shown in FIG. 3A was designed to test the performance of the phase masks and the imaging system 10. A laser beam with a wavelength of 632 nm emitted from a fibre is expanded with a set of telescopic lenses L1, then passes mirrors M1 and M2. The two (2) mirrors ensure that the beam reaches a 50/50 beamsplitter BS1 surface vertically and is divided into bottom and top beams. These two (2) beams are reflected by mirrors M3 and M4, respectively, which enables two (2) beams to interfere with each other at a 50/50 beamsplitter BS2. Two phase masks P1 and P2 are installed after the mirrors M3 and M4 to introduce phase change. The directions of P1 and P2 are opposite. BS2 is installed on a one-dimensional guide to induce an optical path difference between the two paths. A lens L2 with f=200 mm is installed 200 mm after the center of BS2 and the distance between an sCMOS camera (Thorlabs, DCU224M-GL) and the lens is also 200 mm.

Referring now to FIGS. 3B and 3C, simulated PSFs in several positions at Z=0 nm, 60 nm, 120 nm and 240 nm with rotating angles of the vortex being respectively Δθ=0°, 45°, 90° and 180° are shown in FIG. 3B and corresponding measured PSFs by moving BS2 along the azimuthal direction are shown in FIG. 3C. By moving BS2 in the azimuthal direction in the range of 0-240 nm, the simulated and measured PSFs pattern are found to be rotating accordingly, as shown in FIGS. 3B and 3C. Altogether, this provides a proof-of-concept validation for the imaging system 10.

To analyse resolution performance, the single-molecule localization parameters (e.g., (x, y, z, Nₚₕ, N_{bg})) are estimated through solving a fitting problem using the detection PSFs with localization precision estimated by Cramer-Rao Lower Bound (CRLB). In information theory, CRLB defines the lower bounds of the variance of any unbiased estimator. Therefore, the accuracy of the molecule parameters θᵢ is defined by Equation (6) below:

$${σ}_{i} \geq \sqrt{C R L {B}_{i}} \qquad ( 6 )$$

while CRLBᵢ is calculated from the Fisher information matrix.

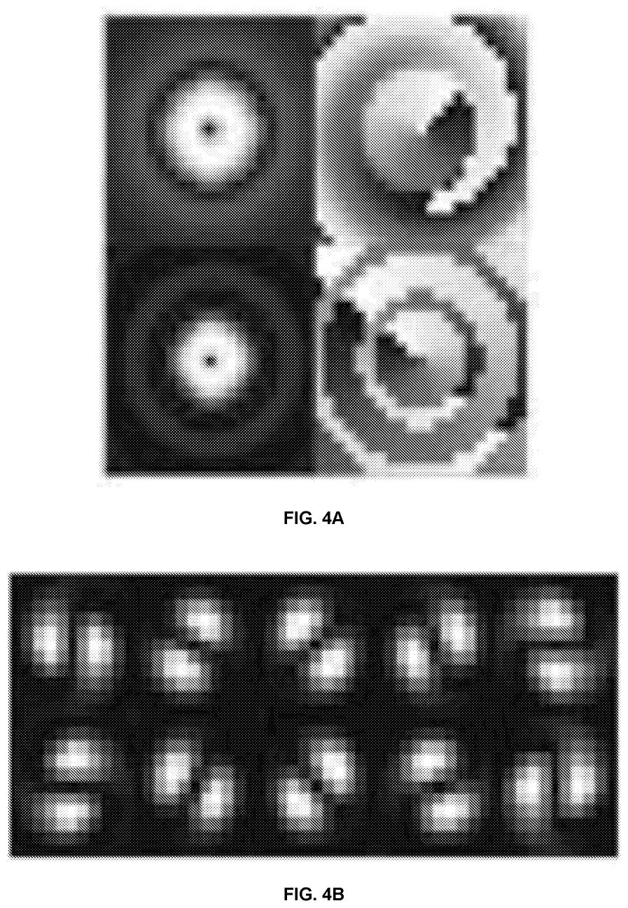

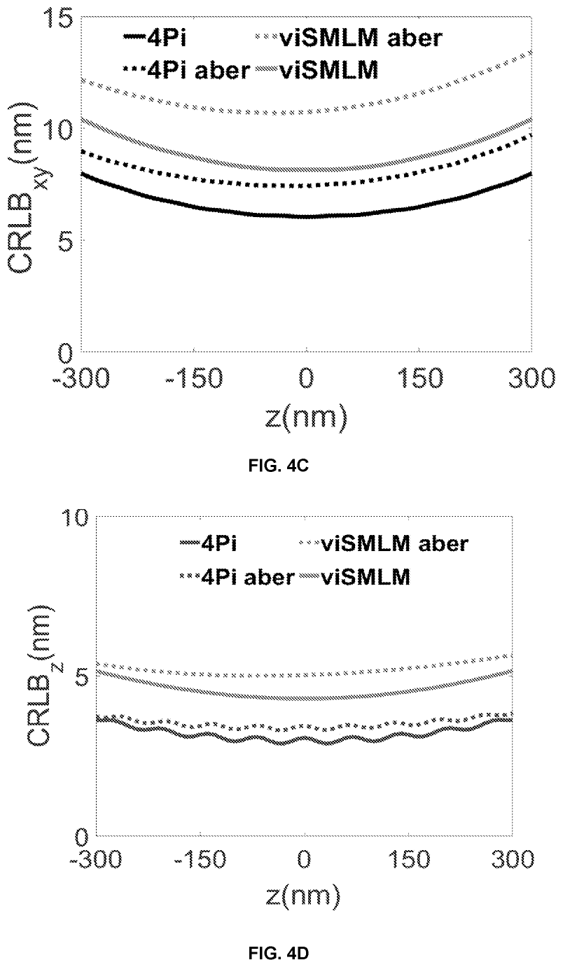

Referring now to FIGS. 4A though 4D, the influence of optical aberration on PSFs of the imaging system 10 was next evaluated. In iSMLM, spherical aberration is the primary source of aberration since for one of the optical arms, the fluorescence emission must traverse the whole sample thickness prior to reaching the objective lens. Here, assuming TIRF illumination from the lower objective lens, the emission collected by the upper objective lens will be most significantly affected by spherical aberration.

Amplitude and phase of coherent PSFs for two cameras before interference are shown in FIG. 4A. Spherical aberrations can be seen from the PSF of the first camera. In FIG. 4A, the PSFs for the upper and lower arms were calculated, assuming a sample thickness of 10 μm, with each objective lens focused at a plane with the most signal photons.

PSFs for the two cameras of the imaging system 10 under the influence of spherical aberration are shown in FIG. 4B. As shown in FIG. 4B, the aberrated upper-arm PSF appears to be more smoothened with a wider centre ring in comparison to the unaberrated lower-arm PSF. Nevertheless, since the vortex phase modulation is less sensitive to aberrations, the rotation in the phase is still maintained. Thus, as shown in FIG. 4B, the qualitative effect of spherical aberration on the imaging system 10 is in causing a slight blurring of the lobes of the PSF, while still preserving clear double-helix rotation profile.

To quantitatively assess the contribution of spherical aberration, analysis of CRLB was next performed as shown in FIGS. 4C and 4D. Theoretical 3D precisions between 4Pi PSF and viSMLM PSF with and without the spherical aberration are shown in shown in FIGS. 4C and 4D. 1000 signal and 20 background photons were considered. It was found that spherical aberration induced blurring of the PSF lobes contributed to the deterioration of the lateral resolution by a factor of 1.3. On the other hand, the axial resolutions were affected to a smaller extent by a factor of 1.1. Taken together, the analysis suggests that the influence of optical aberration on both the lateral and axial resolutions should be manageable, especially for thin specimens such as cell mono-layer. In practice, such spherical aberration can also be partly compensated by correction collar in the objective lens or for thicker samples via adaptive optics approach.

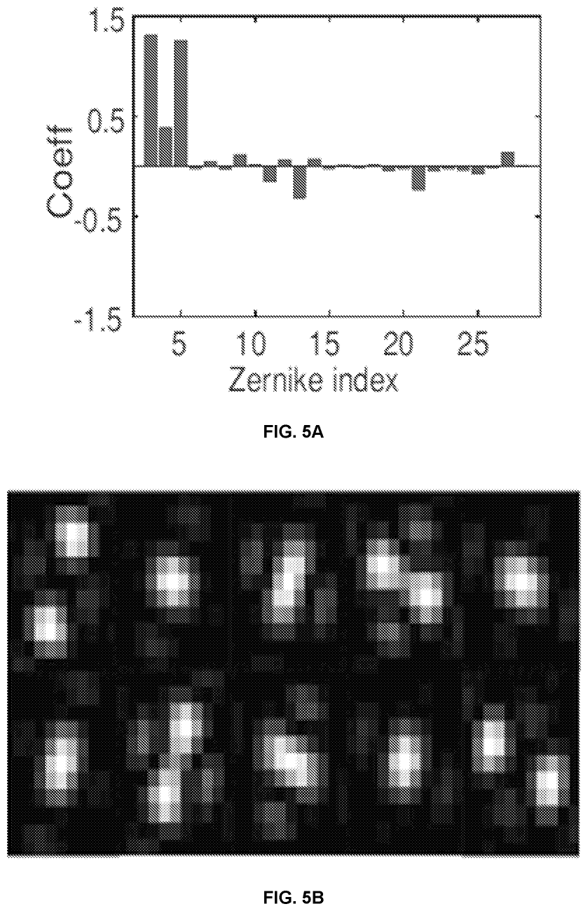

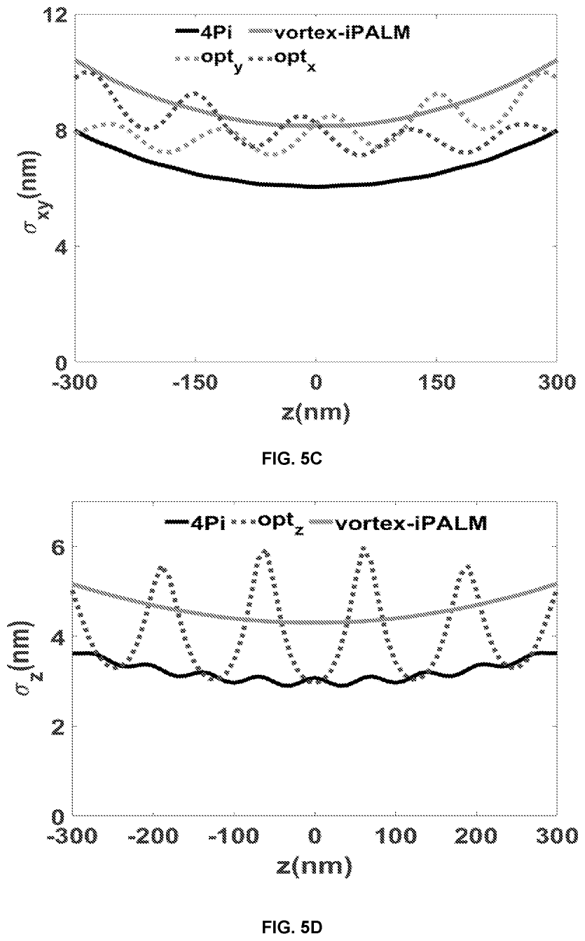

Referring now to FIGS. 5A though 5D, an assessment was made as to whether the imaging system 10 was capable of achieving optimal super-resolution performance. Zernike modes were used to compose a pupil function T, and the best pupil function that would yield a PSF with optimal Fisher information properties was determined. Based on this approach, optimal Zernike modes that realize iSMLM using a single beamsplitter were calculated with a key modification in that the axial resolution was optimized as much as possible, while not seeking to extend the axial range. Hence, the depth of range Z was set to (−300 nm, 300 nm) and the optimization problem was modified as represented by Equation (7) below:

$${min}_{T} \{ \frac{1}{{N}_{z}} {\sum }_{i = x , y , z} {\sum }_{z ∈ Z} \sqrt{C R L {B}_{i} ( z )} + {max}_{z ∈ Z} \sqrt{C R L {B}_{z} ( z )} \} \qquad ( 7 )$$

whereby the last term serves to avoid fluctuation in the axial resolution and forces the best axial resolution. A total of 25 Zernike modes were used to compose the pupil functions T, while N_{z} represents the number of samples in the whole depth range.

The resulting coefficients of the Zernike modes with OSA/ANSI index is shown in FIG. 5A; coefficients for the optimized Zernike PSF are shown in FIG. 5A. It was noted that the oblique and vertical astigmatism modes clearly dominate over other modes.

Optimized Zernike PSFs for each camera are shown in FIG. 5B. Since the coefficients of high order Zernike modes are small and the defocus mode (n=4) influences the symmetry of the localization PSF, only oblique astigmatism and vertical astigmatism modes are kept to compose the optimal Zernike PSF (OptZern PSF) shown in FIG. 5B. In comparison to the 4Pi PSFs and PSFs of the imaging system 10, OptZern PSF appears to be highly structured, containing several bright local maxima and with clear intensity oscillations in the axial direction.

The CRLB localization precision calculated for OptZern PSFs is shown in FIGS. 5C and 5D. More particularly, theoretical 3D precisions between 4Pi PSF, optimized Zernike PSF, and viSMLM PSF are shown in FIGS. 5C and 5D. 1000 signal and 20 background photons were considered. For lateral localization precision, OptZern PSF appears to be comparable to Vortex-iPALM PSF. However, for axial localization precision, while OptZern PSF reaches a lower minimum compared to Vortex-iPALM PSF, a clear oscillation between 3 nm and 6 nm was observed, which resulted in regions where OptZern PSF was less optimal. Notably, the axial resolution performance by vortex-iPALM appeared to be much more uniform and was comparable to the mid-point of the oscillation shown by OptZern PSF. This likely is due to the fact that there was still interference in the axial direction using OptZern PSFs. While this can be mitigated by optimal choices of Zernike mode coefficients modes, this cannot be eliminated. In contrast, for Vortex-iPALM PSF, no axial oscillation was expected since the axial interference was mapped to the azimuthal direction. In practice, this analysis suggests that the Vortex-iPALM PSFs may be comparatively amenable to the peak fitting steps in SMLM analysis, in comparison to OptZern PSFs which might need time-consuming pupil retrieval methods to approximate the theoretical precisions.

In conclusion, the analysis showed that the imaging system 10 may offer 3D resolution performance comparable to optimally achievable limits. The analysis also showed that the imaging system 10 offers a design performance comparable to traditional iPALM/iSMLM especially in terms of 3D resolution and effective z-depth range. The optical realization of counter-rotating PSFs was demonstrated, validating the design. Assessing the PSFs of the imaging system 10 (vortex-iPALM PSF) in comparison with theoretically optimized Zernike PSFs, it was found that the imaging system 10 shows a simpler shape profile and a more uniform 3D performance. The analysis results further showed that the imaging system 10 has a similar performance, including the 3D resolution, depth of range and sensitivity to optical aberrations, with existing iSMLM systems under different experimental conditions. Given the ultra-high 3D resolution and a simpler experimental setup, the imaging system 10 may represent a simpler and practical alternative to current iPALM/ISMLM imaging methods and will be more amenable to commercialization and wide adoption by the scientific research community.

As is evident from the foregoing discussion, the present invention provides an interference-based single-molecule imaging system that utilizes a single beamsplitter and may be implemented using commercially available optical components. Advantageously, by making use of commercially available, instead of bespoke, optical components, instrumentation complexity may be minimized. The new optical design enables 3D imaging with ultra-high precision using a much simplified optical construction which is expected to simplify its operation and system construction.

The imaging system may be applied in a super-resolution fluorescence microscope, live cell single-molecule tracking and correlative super-resolution electron microscopy. The imaging system may be used for ultra-high-resolution three-dimensional (3D) fluorescence imaging of cell biological specimens.

While preferred embodiments of the invention have been described, it will be clear that the invention is not limited to the described embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. An imaging system, comprising:
a beamsplitter;
a first optical arm, comprising:
a first objective lens,
a first phase plate, and
a first mirror arranged to direct emission from the first objective lens through the first phase plate towards the beamsplitter;
a second optical arm, comprising:
a second objective lens, wherein the first and second objective lenses are in an opposing relationship;
a second phase plate, and
a second mirror arranged to direct emission from the second objective lens through the second phase plate towards the beamsplitter; and
one or more detectors arranged to receive an image from the beamsplitter.

2. The imaging system of claim 1, wherein each of the first and second phase plates is a vortex phase plate.

3. The imaging system of claim 1, wherein each of the first and second phase plates is positioned between a corresponding one of the first and second objective lenses and the beamsplitter.

4. The imaging system of claim 1, wherein the first and second objective lenses are co-axially aligned in a 4Pi geometry.

5. The imaging system of claim 1, wherein each of the first and second mirrors is oriented at an angle of about 67.5 degrees (°) relative to a central axis of the corresponding first or second objective lens.

6. The imaging system of claim 1, wherein each of the first and second mirrors is mounted on a two-axis piezoelectric mirror mount.

7. The imaging system of claim 1, wherein the beamsplitter is a non-polarizing beamsplitter.

8. The imaging system of claim 1, wherein the beamsplitter is configured to split unpolarized light at a specific reflection/transmission (R/T) ratio of 50/50.

9. The imaging system of claim 1, further comprising one or more tube lenses, wherein each of the one or more tube lenses is positioned between the beamsplitter and a corresponding one of the one or more detectors.
